(19) United States
(12) Patent Application Publication
(10) Pub. No.: US 2018/0272784 A1
(43) Pub. Date: Sep. 27, 2018

(54) BINDING DEVICE

(71) Applicant: FUJI XEROX CO., LTD., Tokyo (JP)

(72) Inventors: Hiroaki AWANO, Yokohama-shi (JP); Takuya MAKITA, Yokohama-shi (JP); Katsumi HARADA, Yokohama-shi (JP); Kojiro TSUTSUMI, Yokohama-shi (JP); Toshiyasu YUKAWA, Yokohama-shi (JP); Takashi OGINO, Ashigarakami-gun (JP)

(73) Assignee: FUJI XEROX CO., LTD., Tokyo (JP)

(21) Appl. No.: 15/661,627

(22) Filed: Jul. 27, 2017

(30) Foreign Application Priority Data
Mar. 23, 2017 (JP) 2017-058198

(51) Int. Cl. B42B 5/00; B31F 5/02; B65H 37/04

(52) U.S. Cl. CPC B42B 5/00; B65H 2801/27; B65H 37/04; B31F 5/02

(57) ABSTRACT

A binding device includes: a binding unit that forms multiple asperities on a recording material bundle constituted by rectangular recording materials, and binds the recording material bundle, wherein, in oblique binding in which the multiple asperities are arranged on a corner portion of the recording material bundle in a direction inclined to one of both sides constituting the corner portion of the recording material bundle, a binding position by the binding unit reaches at least one of the both sides constituting the corner portion of the recording material bundle, and, in parallel binding in which the multiple asperities are arranged along a side of the recording material bundle, a binding position by the binding unit does not reach any side of the recording material bundle.

### CROSS REFERENCE TO RELATED APPLICATIONS

This application is based on and claims priority under 35 USC § 119 from Japanese Patent Application No. 2017-058198 filed Mar. 23, 2017.

### BACKGROUND

### Technical Field

The present invention relates to a binding device.

### Related Art

In recent years, a post-processing device for an image forming system including a stapleless binding unit to bind a sheet bundle without using staples, in addition to a stapler, has been suggested.

### SUMMARY

According to an aspect of the present invention, there is provided a binding device including: a binding unit that forms multiple asperities on a recording material bundle constituted by rectangular recording materials, and binds the recording material bundle, wherein, in oblique binding in which the multiple asperities are arranged on a corner portion of the recording material bundle in a direction inclined to one of both sides constituting the corner portion of the recording material bundle, a binding position by the binding unit reaches at least one of the both sides constituting the corner portion of the recording material bundle, and, in parallel binding in which the multiple asperities are arranged along a side of the recording material bundle, a binding position by the binding unit does not reach any side of the recording material bundle.

### BRIEF DESCRIPTION OF THE DRAWINGS

An exemplary embodiment of the present invention will be described in detail based on the following figures, wherein:

FIG. 1 shows a configuration of an image forming system to which the exemplary embodiment is applied;

FIG. 2 is a diagram showing a compiler stacking section to which the exemplary embodiment is applied and a peripheral configuration thereof;

FIG. 3 is a diagram showing the compiler stacking section to which the exemplary embodiment is applied and the peripheral configuration thereof as viewed from the direction III in FIG. 2;

FIGS. 4A and 4B are diagrams illustrating a configuration of a stapleless binding device and an embossed mark formed by the stapleless binding device, respectively;

FIGS. 5A to 5J are diagrams illustrating operations of the stapleless binding device to which the exemplary embodiment is applied and embossed marks formed by the respective operations;

FIGS. 6A to 6H are diagrams illustrating embossed marks formed by the stapleless binding device to which the exemplary embodiment is applied;

FIGS. 7A to 7D are diagrams for illustrating a relationship between binding orientation in duplex printing and single-side reaching oblique binding, to which the exemplary embodiment is applied; and

FIG. 8 is a flowchart showing contents of image forming control to which an exemplary embodiment is applied.

### DETAILED DESCRIPTION

Hereinafter, an exemplary embodiment according to the present invention will be described in detail with reference to attached drawings.

### <Image Forming System 1>

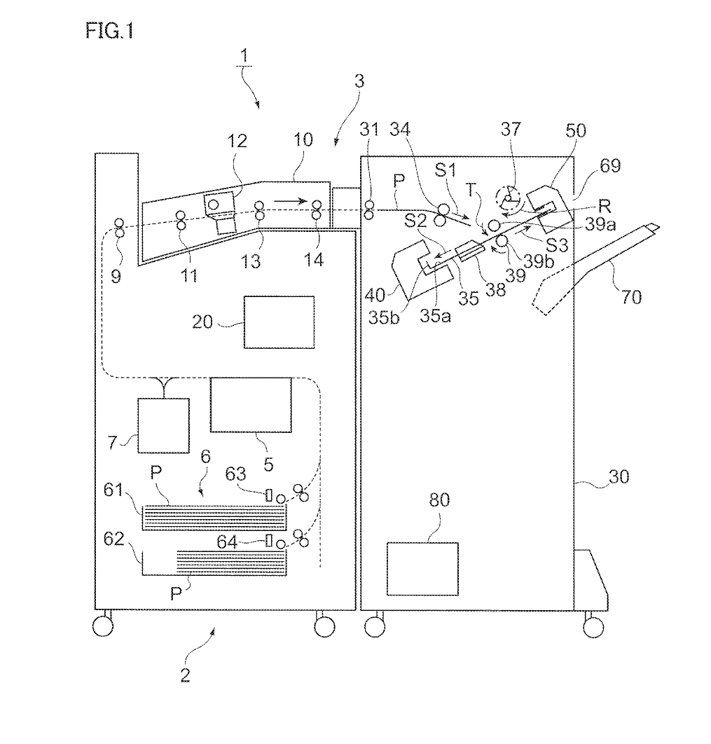

FIG. 1 shows a configuration of an image forming system 1 to which the exemplary embodiment is applied.

The image forming system 1 functioning as an example of an image forming apparatus includes, for instance; an image forming device 2, such as a printer or a copying machine, that forms an image on a sheet P, which is a rectangular recording material, by the electrophotographic system; and a sheet processing device 3 that performs post processing to a sheet P on which an image is formed by the image forming device 2.

### <Image Forming Device 2>

The image forming device 2 includes: a sheet supply section 6 that supplies the sheet P; an image forming section 5 that forms an image on the sheet P supplied from the sheet supply section 6; a sheet inversion device 7 that is detachably attached to the image forming device 2 and inverts the surface of the sheet P on which the image has been formed by the image forming section 5; and an output roller 9 that outputs the sheet P on which the image has been formed.

Moreover, the image forming device 2 includes a controller 20 that performs a user interface function for accepting information related to a binding process from a user or other various kinds of controls.

The sheet supply section 6 contains the sheets P inside thereof, and includes a first sheet P container section 61 and a second sheet P container section 62 that supply the contained sheets P to the image forming section 5. Moreover, inside the first sheet P container section 61 and the second sheet P container section 62, a first sheet supply sensor 63 and a second sheet supply sensor 64 to detect presence or absence of the sheets P are provided, respectively.

<Sheet processing device 3>

The sheet processing device 3 includes: a transport device 10 that further transports the sheet P outputted from the image forming device 2 to a downstream side; and a post-processing device 30 that performs post processing, such as stacking and bundling the sheets P or binding the sheets P that have been bundled. The transport device 10 functions as an example of a transport unit that transports a recording material on which an image has been formed.

Moreover, the sheet processing device 3 includes a controller 80 that functions as an example of a controller that controls a binding unit and also functions as an example of a recognition unit that recognizes print information in a case where a bundle of recording materials is bound in oblique binding.

The transport device 10 is provided with: an inlet roller 11 that receives the sheet P outputted by the output roller 9 of the image forming device 2; and a puncher 12 that punches a hole in the sheet P received by the inlet roller 11 as needed. Moreover, the transport device 10 includes: a first transport roller 13 that is provided downstream of the puncher 12 to transport the sheet P passed through the puncher 12 to a downstream side; and a second transport roller 14 that transports the sheet P transported by the first transport roller 13 toward the post-processing device 30.

The post-processing device 30 includes: a receiving roller 31 that receives the sheet P from the transport device 10; a compiler stacking section 35 that is provided downstream of the receiving roller 31 to function as a container unit that collects and stacks multiple sheets P; and an exit roller 34 that outputs the sheet P received by the receiving roller 31 in the direction S1 in FIG. 1 toward the compiler stacking section 35.

Moreover, the post-processing device 30 is provided with: a paddle 37 that rotates to push the sheet P, which has been outputted by the exit roller 34 around the compiler stacking section 35, in the direction S2 in FIG. 1 toward an end guide 35b (to be described later) that is one side surface of the compiler stacking section 35; a tamper 38 that pushes in the sheet P toward a side guide 35c (to be described later) that is another side surface of the compiler stacking section 35; and an eject roller 39 that presses the sheets P collected in the compiler stacking section 35 and transports a sheet bundle S, which has been subjected to post processing, in the direction S3 in FIG. 1 toward the downstream side.

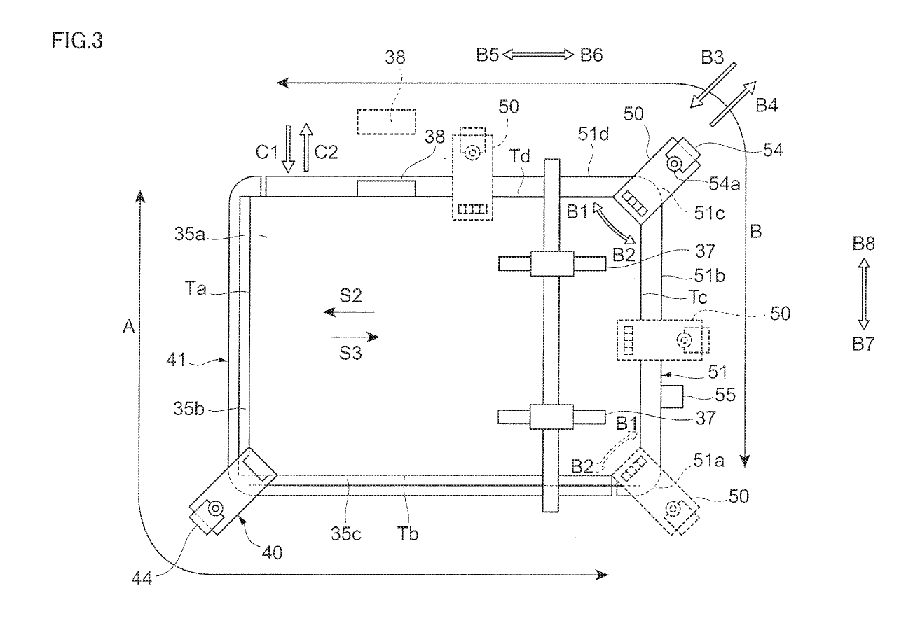

Moreover, the post-processing device 30 is provided with: a stapler 40 that binds a sheet bundle S, which is an example of a recording material bundle formed by the sheets P collected in the compiler stacking section 35, with a staple; a stapleless binding device 50 that forms multiple asperities on the sheet bundle S to bind thereof without using the staple; a stapler rail 41 (refer to FIG. 3) that guides movement of the stapler 40; and a rail 51 (refer to FIG. 3) that guides movement of the stapleless binding device 50. The stapleless binding device 50 functions as a binding unit that forms a binding mark including multiple asperities in one direction on a recording material bundle constituted by rectangular recording materials and binds thereof. Moreover, the stapleless binding device 50 functions as a first binding unit that binds a recording material bundle by forming multiple asperities arranged over a first length on a corner portion of the recording material bundle, and also functions as a second binding unit that binds a recording material bundle by forming multiple asperities arranged over a second length, which is longer than the first length, in parallel with one side of the recording material bundle. Moreover, the stapler rail 41 and the rail 51 are independent from each other.

Further, the post-processing device 30 is provided with: an opening section 69 for outputting the sheet bundle S that has been subjected to the post processing and transported by the eject roller 39; and a stacker 70 for stacking the sheet bundle S after the post processing to be taken by a user with ease.

### <Compiler Stacking Section 35 and Peripheral Configuration Thereof>

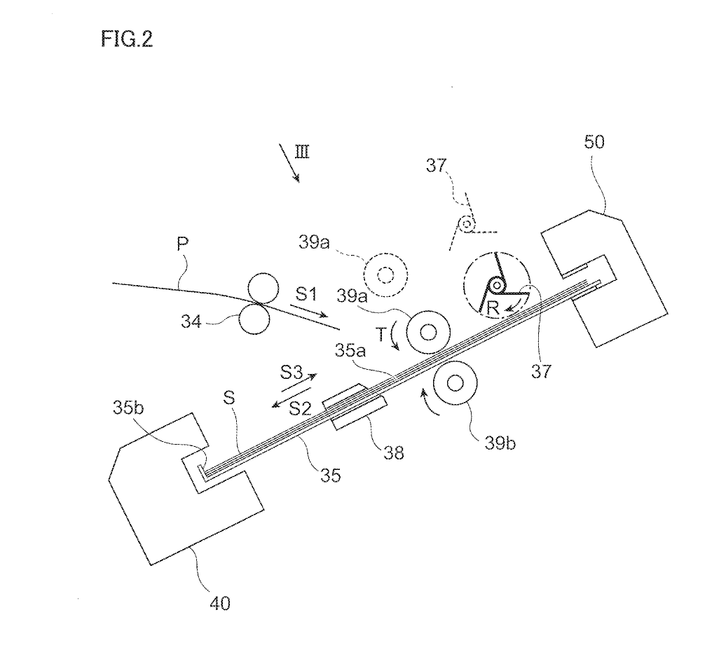

Next, description will be provided in detail of the compiler stacking section 35, and the paddle 37, the tamper 38, the eject roller 39, the stapler 40, the stapleless binding device 50, the stapler rail 41 and the rail 51 that are provided around the compiler stacking section 35 by using FIGS. 2 to 4A-4B.

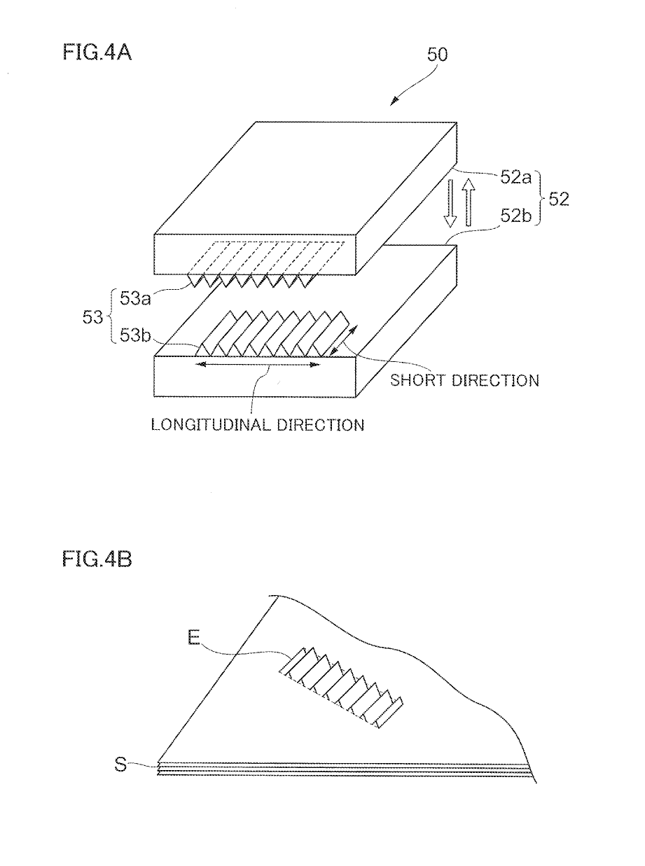

Here, FIG. 2 is a diagram showing the compiler stacking section 35 to which the exemplary embodiment is applied and the peripheral configuration thereof, and FIG. 3 is a diagram showing the compiler stacking section 35 to which the exemplary embodiment is applied and the peripheral configuration thereof as viewed from the direction III in FIG. 2. Moreover, FIG. 4A is a diagram illustrating a configuration of the stapleless binding device 50, and FIG. 4B is a conceptual view of an embossed mark formed by the stapleless binding device 50.

As shown in FIGS. 2 and 3, the compiler stacking section 35 includes: a bottom section 35a that is an upper surface for stacking the sheets P; the end guide 35b that is a side surface of the compiler stacking section 35 for aligning the end portions of the sheets P; and the side guide 35c. The upper surface of the bottom section 35a is formed larger than the size of the sheet P to be stacked, and has a rectangular shape. The end guide 35b and the side guide 35c are side surfaces adjacent to each other and provided around the bottom section 35a, and are formed higher than the thickness of the sheet bundle S to be stacked on the bottom section 35a. Moreover, when the sheet bundle S is generated, the end guide 35b aligns the leading edges of the sheets P transported in the direction S2, and the side guide 35c aligns the edges adjacent to the leading edges of the sheets P.

The paddle 37 is provided upstream of the compiler stacking section 35 and downstream of the exit roller 34 in the direction S1 in which the sheet P is transported. The paddle 37 rotates in the direction R in FIG. 2 to push in the sheet P in the direction S2 toward the end guide 35b.

The tamper 38 is provided on an end Td side of the compiler stacking section 35 to face the end guide 35b. The tamper 38 pushes the sheets P toward the side guide 35c by moving in the direction C1. The eject roller 39 includes a first eject roller 39a and a second eject roller 39b disposed above and below the bottom section 35a, respectively. The first eject roller 39a and the second eject roller 39b press the sheets P, which are stacked on the bottom section 35a, against the bottom section 35a. Moreover, the sheet bundle S is transported in the direction S3 by rotation of the first eject roller 39a in the direction T in FIG. 2.

Next, by using FIG. 3, description will be given of the stapleless binding device 50 provided to bind the sheet bundle S and the rail 51 for guiding movement of the stapleless binding device 50, and the stapler 40 and the stapler rail 41 for guiding movement of the stapler 41.

The stapleless binding device 50 provides pressure to the sheet bundle S without using any staple, breaks fibers of the sheets P and bonds the fibers with pressure, to thereby perform a process of binding the sheet bundle S aligned in the compiler stacking section 35. Moreover, the stapleless binding device 50 includes a stapleless binding drive section 54 that drives operations of the stapleless binding device 50. It is possible to cause the stapleless binding drive section 54 to function as an example of a moving unit that moves the binding unit to change a position and an angle thereof in the recording material bundle. However, it is also possible to provide a moving unit independently of the stapleless binding drive section 54.

The rail 51 is provided on end Tc and Td sides of the compiler stacking section 35 around the compiler stacking section 35. The rail 51 is a continuous rail, and includes linear portions 51b and 51d formed in parallel with the ends Tc and Td of the compiler stacking section 35, respectively, and curved portions 51a and 51c formed around corner portions on both sides of the end Tc of the compiler stacking section 35.

Moreover, the rail 51 includes a rail drive section 55 that moves the rail 51 itself in parallel. In other words, upon receiving a driving force from the rail drive section 55, the rail 51 moves in parallel with the compiler stacking section 35 in the directions B3 to B8 in FIG. 3 in accordance with the size, orientation, the binding position, and so forth, of the sheet P to be supplied.

The stapler 40 pushes a staple in the sheet bundle S aligned by the compiler stacking section 35, to thereby perform the binding process. Moreover, the stapler 40 includes a stapler drive section 44 that drives operations of the stapler 40. The stapler 40 is configured to be, upon receiving a driving force from the stapler drive section 44, capable of performing the binding process and moving in the direction A on the stapler rail 41.

The stapler rail 41 is provided on end Ta and Tb sides of the compiler stacking section 35, which is a position facing the position where the rail 51 is formed in the compiler stacking section 35.

### <Stapleless Binding Device 50>

Subsequently, the configuration of the stapleless binding device 50 will be described in detail by using FIGS. 3 and 4A-4B.

As shown in FIG. 4A, the stapleless binding device 50 includes: a press section 52 that applies pressure to process an end portion of the sheet bundle S by causing parts thereof to approach each other; and an embossing process section 53 that performs an embossing process to the sheet bundle

S upon receiving the pressure from the press section 52. The press section 52 includes an upper press section 52a and a lower press section 52b (the above-described “parts”), and the upper press section 52a and the lower press section 52b include upper teeth 53a, which is a part of the embossing process section 53, and lower teeth 53b, which is the other part of the embossing process section 53b, respectively. The press section 52 operates upon receiving the driving force from the stapleless binding drive section 54.

The stapleless binding drive section 54 includes a not-shown drive source and a transmission mechanism that transmits a driving force from the drive source. The stapleless binding drive section 54 has a rotation shaft 54a that serves as a rotation center in rotating the embossing process section 53 in the directions B1 and B2 in FIG. 3. The stapleless binding drive section 54 changes an angle in the binding process to be performed to the sheet bundle S by rotating the embossing process section 53 around the rotation shaft 54a.

In the upper teeth 53a and the lower teeth 53b, as shown in FIG. 4A, multiple convex portions are arranged along the tip end of the upper press section 52a, and thereby, multiple continuous asperities are formed. The shape made of the multiple asperities is substantially a rectangular body assuming the direction in which the asperities continue as a longitudinal side, and accordingly, the direction in which the asperities continue is assumed to be the longitudinal direction. In the lower teeth 53b, multiple convex portions are arranged so that the concave portion of the lower teeth 53b engages with the convex portion of the upper teeth 53a, and the lower teeth 53b faces the upper teeth 53a.

The asperities (embossed mark E) formed on the sheet bundle S by the embossing process section 53 are, as shown in FIG. 4B, formed to be arranged in one direction (the longitudinal direction) on the surface of the sheet bundle S, and to extend over the thickness direction of the sheet bundle S (piling direction of the sheets P). In the portion of the embossed mark E of the sheets P that has been pressed and deformed, the fibers constituting the sheets P are broken, and the sheets P are subjected to pressure bonding.

In such an embossed mark E, the larger the number of asperities constituting the mark is, the more the portions pressure-bonded to the sheet bundle S become; accordingly, the binding force by the embossed mark E is increased. In other words, the longer the length of the embossing process section 53 that forms the embossed mark E in the longitudinal direction is made, the larger the binding force obtained by the embossing process section 53 becomes.

### <Operations of Stapleless Binding Device 50>

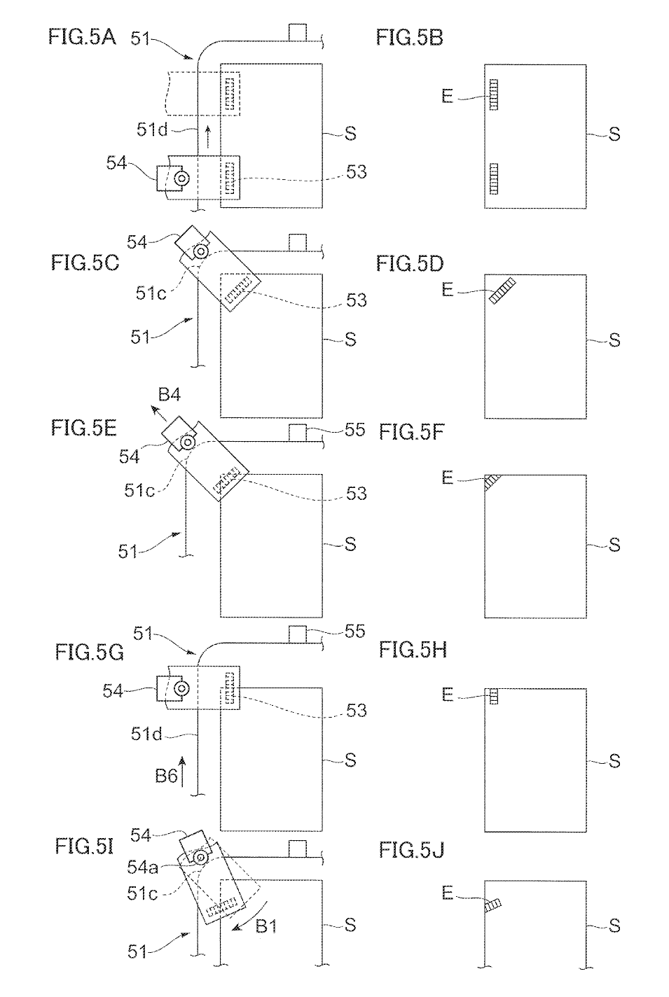

Subsequently, the operations of the stapleless binding device 50 will be described by using FIGS. 3, 4A-4B and 5A-5J. Here, FIGS. 5A to 5J are diagrams illustrating operations of the stapleless binding device 50 to which the exemplary embodiment is applied, and embossed marks E formed by the respective operations.

First, the stapleless binding device 50 that has received a signal from the controller 80 moves to a predetermined binding position, and performs the binding process to the sheet bundle S at the binding position. Here, the binding position includes a position of the stapleless binding device 50 with respect to the sheet bundle S and an angle of the stapleless binding device 50 with respect to the sheet bundle S at the position.

The operations of the stapleless binding device 50 are configured with a binding operation to perform the binding process to the sheet bundle S at the predetermined binding position and a moving operation to move to the binding position. As the moving operation of the stapleless binding device 50, there exist first movement along the rail 51 (in the direction B) driven by the stapleless binding drive section 54 and second movement in which the stapleless binding device 50 moves as a result of movement of the rail 51 itself. Moreover, as the moving operation of the stapleless binding drive section 54, there exists rotation movement that rotates the embossing process section 53 around the rotation shaft 54a. The stapleless binding device 50 changes the binding position with respect to the sheet bundle S by the control of the controller 80.

In the first movement, which is the movement of the stapleless binding device 50 along the rail 51, the stapleless binding device 50 moves not only in a linear direction, but also in oblique directions along the curved portions 51a and 51c of the rail 51. The stapleless binding device 50 can perform oblique binding, in which the binding position (the longitudinal direction of the embossing process section 53) is inclined to a side of the sheet bundle S, to the sheet bundle S at the curved portions 51a and 51c of the rail 51. Moreover, when moving along the linear portions 51b and 51d of the rail 51, the stapleless binding device 50 performs binding process (parallel binding) to an end portion (a side portion) of the sheet bundle S, in which the binding position is located along the side of the sheet bundle S.

Moreover, in the second movement in which the stapleless binding device 50 moves by the movement of the rail 51 itself, inward movement of the rail 51 (in the directions B3, B5 and B7) and outward movement of the rail 51 (in the directions B4, B6 and B8) are carried out. The stapleless binding device 50 can perform a binding process in which the binding position does not reach any side of the sheet bundle S (non side-reaching binding) by performing the binding process after the inward movement is carried out. On the other hand, the stapleless binding device 50 can perform a binding process in which the binding position reaches at least one side of the sheet bundle S (side-reaching binding) by performing the binding process after the outward movement is carried out.

Further, in the rotation movement in the directions B1 and B2, which is another mode of the second movement of the stapleless binding device 50, the stapleless binding device 50 can perform oblique binding in which the binding position reaches one side of the sheet bundle S in the rotation direction (single-side reaching oblique binding).

### <Mode of Binding Position and Embossed Mark E>

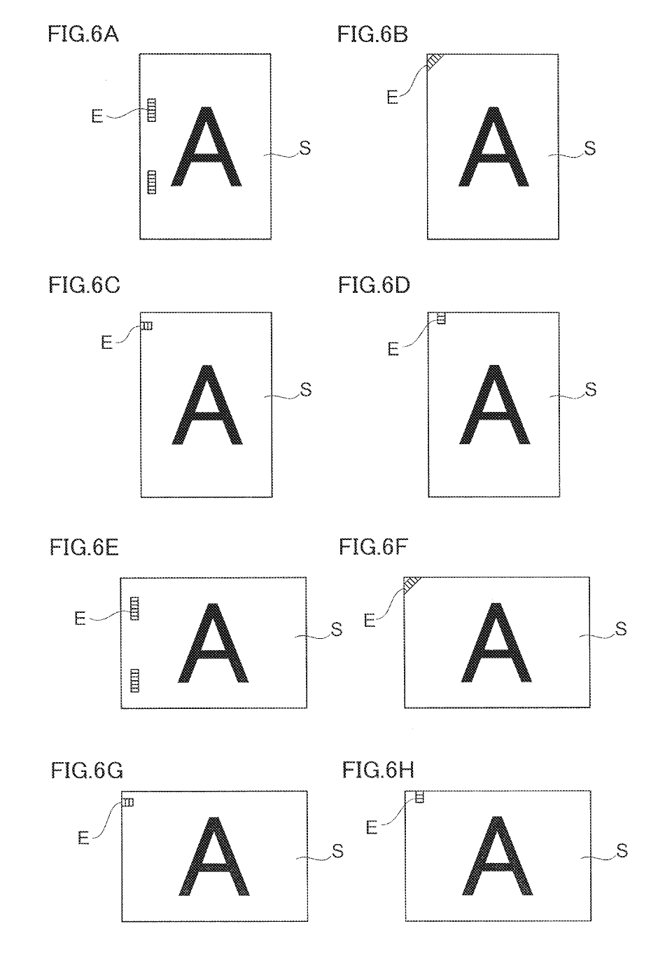

Subsequently, the mode of the binding position of the stapleless binding device 50 and the embossed mark E will be described in detail by using FIGS. 5A-5J and 6A-6H. FIGS. 6A to 6H are diagrams illustrating the embossed marks E formed by the stapleless binding device 50 to which the exemplary embodiment is applied.

First, binding that does not reach any side of the sheet bundle S is shown in FIGS. 6A and 6E. The binding that does not reach any side of the sheet bundle S is the parallel binding that extends along one side of the sheet bundle S (a long side or a short side) and in parallel with the side. Since the binding position of the stapleless binding device 50 does not reach any side of the sheet bundle S, the embossed mark E by the full length of the embossing process section 53 in the longitudinal direction is formed on the sheet bundle S. Moreover, as shown in FIGS. 6A and 6E, the stapleless binding device 50 forms the embossed marks E at two places in many cases; however, in addition, the binding process can be performed multiple times (multi-place binding).

On the other hand, in the side-reaching binding that reaches at least one side of the sheet bundle S, as shown in FIGS. 6B-6D and 6F-6H, there are three types, namely, single-side reaching parallel binding; single-side reaching oblique binding (refer to FIG. 5J), and double-side reaching oblique binding. These side-reaching binding modes are the binding process to be performed to the corner portion of the sheet bundle S (corner-portion binding). Moreover, in the side-reaching binding, since the binding position of the stapleless binding device 50 reaches at least one side of the sheet bundle S, the embossed mark E by a part of length of the embossing process section 53 in the longitudinal direction is formed on the sheet bundle S.

Here, in the exemplary embodiment, the size of the embossed mark E (the embossing process section 53) in the longitudinal direction is made longer to obtain large binding force in performing the parallel binding. Moreover, in the exemplary embodiment, by use of the same stapleless binding device 50 (the embossing process section 53), the parallel binding and the corner-portion binding are performed. At this time, if the length of the embossed mark E used in the parallel binding is also employed as it is for the corner-portion binding, the embossed mark E is formed largely inward from the corner portion of the sheet bundle S. If the embossed mark E is placed largely inward in this manner, it becomes impossible to input information in a relatively large region inward from the corner portion of the sheet P.

Therefore, the exemplary embodiment is configured, in the corner-portion binding, to perform the side-reaching binding in which the binding position by the embossing process section 53 reaches at least one side of the sheet bundle S. Due to the binding position of the stapleless binding device 50 reaching at least one side of the sheet bundle S, a short embossed mark E by use of a part of length of the embossing process section 53 in the longitudinal direction is formed, in contrast to the long embossed mark E formed by the full length of the longitudinal direction in the embossing process section 53. By using the short embossed mark E, a binding formation position is not excessively inside from the corner portion or the side portion of the sheet bundle S, and it is possible to suppress difficulty in turning pages of the sheet bundle S.

### <Control of Each Stapleless Binding Mode>

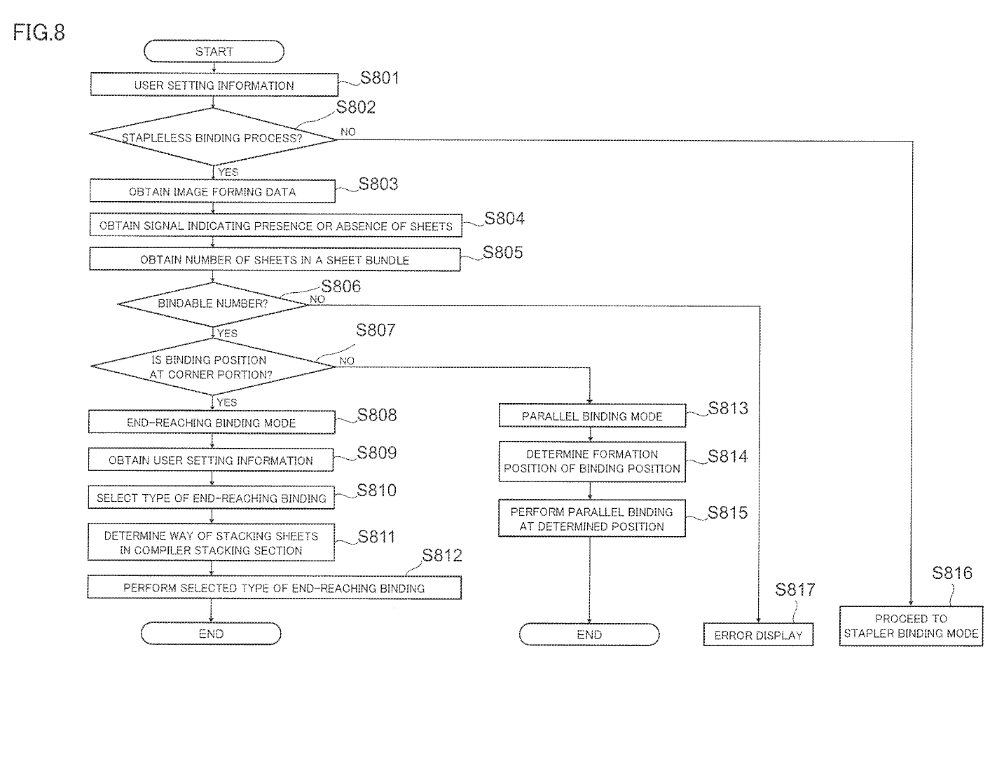

Subsequently, description will be given of control of each stapleless binding mode performed by the controller 20 and the controller 80 by using FIGS. 6A-6H and 8. Here, FIG. 8 is a flowchart showing contents of control to which an exemplary embodiment is applied.

First, the controller 20 provided to the image forming system 1 accepts user setting information related to a binding process obtained through the user interface (step 801).

Here, the user setting information is information necessary to the control performed by the controller 80, which is information selected by a user from various kinds of control information items stored in a memory (not shown) in advance through the user interface of the controller 20, to be set. The user setting information includes binding type information and binding position information. Moreover, the binding type information includes stapler binding process information and stapleless binding process information, and the binding position information includes parallel binding information and corner-portion binding information.

The controller 80 obtains binding type information set by a user based on the user setting information accepted in step 801 and determines whether or not the stapleless binding process is set (step 802). When the obtained binding type information is not the stapleless binding process (NO in step 802), the process proceeds to a stapler binding mode (step 816), and a stapler binding process is performed. Here, description of the stapler binding process is omitted. On the other hand, when the obtained binding type information is the stapleless binding process (YES in step 802), the controller 80 performs the stapleless binding process, which will be described later.

In the stapleless binding process, first, image forming data to be formed is obtained (step 803). Moreover, the controller 80 obtains a signal indicating presence or absence of sheets from the first sheet supply sensor 63 or the second sheet supply sensor 64 (step 804). Then, the controller 80 obtains (recognizes) the number of sheets in a single sheet bundle S to be subjected to the stapleless binding process based on the obtained image forming data and the printing mode (simplex printing, duplex printing, and so forth).

Here, the controller 80 determines whether or not the obtained number of sheets P is in the range of the predetermined bindable number (the number that can be bound) (step 806). For example, as the specifications of the post-processing device 30, if the bindable number of the sheets for normal printing in the stapleless binding is 2 to 10, for example, it is determined whether or not the obtained number of sheets P is in the range of 2 to 10. When the obtained number is not in the predetermined range of bindable number (NO in step 806), error indication is provided to the user (step 817) to prompt resetting. On the other hand, when the obtained number of sheets P is in the range of the bindable number (YES in step 806), the controller 80 proceeds to specific control of the stapleless binding process.

First, the controller 80 determines whether or not the binding position is a corner portion of the sheet bundle S (step 807). When it is determined that the binding position is not a corner portion (the binding position is a side portion) (NO in step 807), the parallel binding mode as shown in FIGS. 6A and 6E is selected (step 813). In the parallel binding mode, a formation position of the binding position is determined based on the orientation of the sheet bundle S stacked on the compiler stacking section 35 (step 814), and the parallel binding is performed at the determined formation position (step 815). In this manner, the parallel binding mode is ended.

On the other hand, when it is determined that the binding position is a corner portion (YES in step 807), the controller 80 proceeds to the side-reaching binding mode as shown in any of FIGS. 6B-6D and 6F-6H (step 808). In the side-reaching binding mode, first, the controller 80 obtains user setting information related to the binding set by the user, such as presence or absence of any duplex image, binding orientation of the duplex image, binding orientation of a simplex image, and so forth (step 809). Then, based on the obtained user setting information, one of the side-reaching binding types is selected (step 810). In response to the selected side-reaching binding type, the controller 80 determines the transport direction of the sheets, the printing conditions, such as printing orientation or printing order, a way of stacking the sheets in the compiler stacking section 35 and the like (step 811), and outputs information to the controller 20. The controller 80 moves the stapleless binding device 50 to perform the selected side-reaching binding to the sheet bundle S stacked on the compiler stacking section 35 (step 812). In this manner, the side-reaching binding mode is ended. Note that, here, a configuration may be made to select, in the side-reaching binding mode, to perform side-reaching binding in the parallel binding or side-reaching binding in the oblique binding.

### <Description of Single-Side Reaching Oblique Binding>

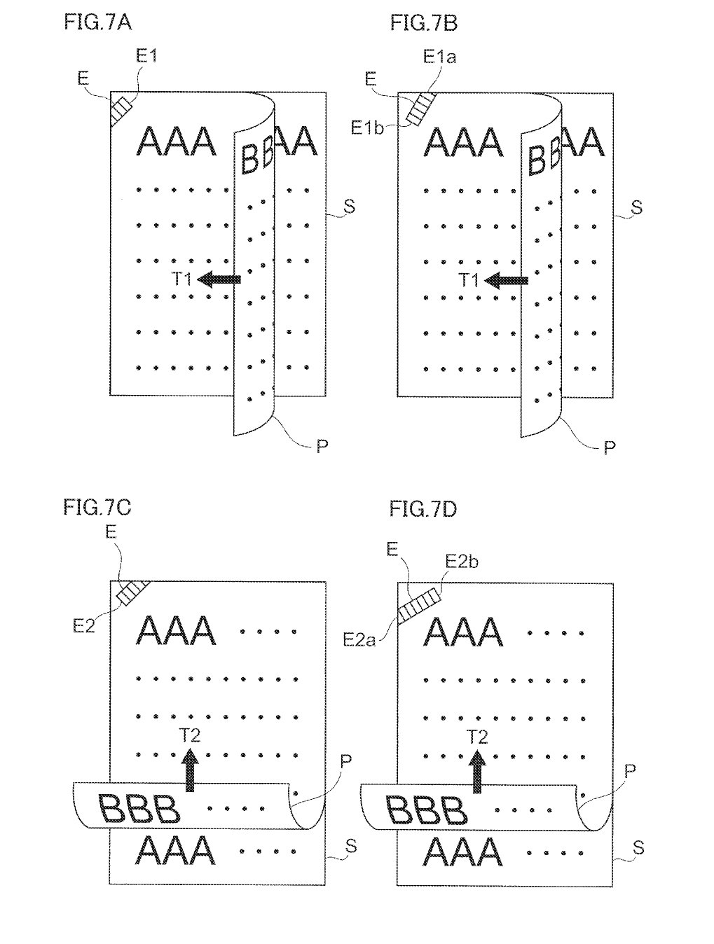

Next, in the side-reaching binding mode, description will be given of the type reaching only a single side to perform oblique binding (single-side reaching oblique binding) by using FIGS. 7A to 7D. FIGS. 7A and 7B are diagrams for illustrating relationship between the binding orientation in the duplex printing and the single-side reaching oblique binding: FIG. 7A shows a case in which the top-left corner portion is bound in the duplex printing of the so-called long-side binding; and FIG. 7B shows a case in which the top-left corner portion is bound in the duplex printing of the so-called short-side binding.

A case in which a user turns pages of the sheet bundle S will be considered. In the type shown in FIG. 7A, since the vertical direction (top and bottom) of the print information is not inverted in the duplex printing, turning of pages is generally performed from side to side. In the side-to-side turning of pages, assuming that the top-left corner portion is bound, it is considered that, in general, a user holds the right end of the sheet P and turns the pages of the sheet bundle P in the direction from right to left of the sheet P (in the direction T1 in the figure). When being turned in the direction T1, the sheet P is turned from the right end E1 of the embossed mark E at the binding root of the embossed mark E. In the type shown in FIG. 7A, the right end E1 of the embossed mark E does not reach an upper side of the sheet bundle S. Therefore, when the turning direction is slightly inclined to the lower direction, the right end E1 of the embossed mark E, which has weakness against turning, receives a force of turning the sheet P; accordingly, the sheet bundle S is likely to be disassembled (the portion bound by the embossed mark E is likely to come off) due to turning of pages.

On the other hand, in the type shown in FIG. 7B, the sheet P is turned from the right end E1a of the embossed mark E at the binding root of the embossed mark E. In the type shown in FIG. 7B, the right end E1a of the embossed mark E reaches the upper side of the sheet bundle S. Therefore, even when the turning direction is slightly inclined to the lower direction, since the portion of the embossed mark E having weakness against turning (a location corresponding to E1 in FIG. 7A) does not receive the force of turning the sheet P, it is possible to suppress disassembly of the sheet bundle S (coming off of the portion bound by the embossed mark E) due to turning of pages. Moreover, for making the length of the embossed mark E longer to obtain a strong binding force, the angle of the embossed mark E is made closer to perpendicularity than 45 degrees.

Next, as shown in FIG. 7C, when the vertical direction (top and bottom) of the print information is inverted in the duplex printing, turning of pages is generally performed from bottom up. In the upward turning of pages, assuming that the top-left corner portion is bound, it is considered that, in general, a user holds the lower end of the sheet P and turns the pages of the sheet bundle P in the direction from bottom to top of the sheet P (in the direction T2 in the figure). When being turned in the direction T2, the sheet P is turned from the left end E2 of the embossed mark E at the binding root of the embossed mark E. In the type shown in FIG. 7B, the left end E2 of the embossed mark E does not reach a left side of the sheet bundle S. Therefore, when the turning direction is slightly inclined to the lower direction, the left end E2 of the embossed mark E receives a force of turning the sheet P; accordingly, the sheet bundle S is likely to be disassembled (the portion bound by the embossed mark E is likely to come off) due to turning of pages.

On the other hand, in the type shown in FIG. 7D, the sheet P is turned from the left end E2a of the embossed mark E at the binding root of the embossed mark E. In the type shown in FIG. 7D, the left end E2a of the embossed mark E reaches the left side of the sheet bundle S. Therefore, even when the turning direction is slightly inclined to the left direction, since the portion of the embossed mark E having weakness against turning (a location corresponding to E2 in FIG. 7C) does not receive the force of turning the sheet P, it is possible to suppress disassembly of the sheet bundle S (coming off of the portion bound by the embossed mark E) due to turning of pages. Moreover, for making the length of the embossed mark E longer to obtain a strong binding force, the angle of the embossed mark E is made closer to horizontality than 45 degrees

In this manner, by selecting a reaching side or an angle in the single-side reaching oblique binding in accordance with the orientation of duplex printing (longitudinal direction or short direction) or a binding position, it is possible to suppress disassembly of the sheet bundle S (coming off of the portion bound by the embossed mark E) due to turning of pages and to obtain a stronger binding force, as compared to a case in which the oblique binding is performed to reach a side without selecting a reaching side.

### FIRST MODIFIED EXAMPLE

In the above-described exemplary embodiment, the description has been given of examples in which the stapleless binding device 50 including a single embossing process section 35 (a single length of the embossing process section 35) is used and the side-reaching binding is performed to reduce the embossed mark E in the corner-portion binding. Instead of the exemplary embodiment, it is possible to employ a configuration in which, in the post-processing device 30 capable of performing both of the parallel binding and the corner-portion binding, independent of the embossing process section 35 used for the parallel binding, another exemplary embodiment 35 used for the corner-portion binding is provided, and these embossing process sections 35 have different lengths. In other words, as compared to the length of each of the embossed marks E in the parallel binding in which multiple embossed marks E are arranged along a side of the sheet bundle S, the length of the embossed mark E in the corner-portion binding to perform binding to the corner portion of the sheet bundle S is made shorter. Consequently, the binding formation position is not excessively inside from the corner portion or the side portion of the sheet bundle S, difficulty in turning pages of the sheet bundle S is suppressed, and information can be prevented from being hidden behind the binding mark.

### SECOND MODIFIED EXAMPLE

In the above-described exemplary embodiment, the description has been given of examples in which the side-reaching binding is performed at the corner portion when the corner-portion binding is performed by using the stapleless binding device 50 including a long embossing process section 35 that is suitable to the parallel binding. Instead of the exemplary embodiment, it is possible to employ a configuration in which the parallel binding is performed by use of a stapleless binding device 50 having a short embossing process section 35 that is suitable to the corner-portion binding. In the stapleless binding device 50 including the short embossing process section 35, it becomes impossible to obtain a sufficient binding force in the parallel binding. Therefore, the binding operation by the stapleless binding device 50 is performed multiple times to cause the embossed marks E to be continued, and thereby a long embossed mark E is formed as a result. In other words, assuming that the length of the embossed mark E formed by a single operation of the stapleless binding device 50 is “first length”, it is also possible to form an embossed mark E having “second length” longer than the “first length” by operating the stapleless binding device 50 multiple times. For example, “first length” is applied to the corner-portion binding, and “second length” is applied to the parallel binding. Consequently, since the length of the multiple asperities formed on the sheet bundle S is increased, a large binding force is obtained in the parallel binding, and at the same time, in the corner-portion binding, the binding formation position is not excessively inside from the corner portion or the side portion of the sheet bundle S, difficulty in turning pages of the sheet bundle S is suppressed, and information can be prevented from being hidden behind the binding mark.

The foregoing description of the present exemplary embodiment of the present invention has been provided for the purposes of illustration and description. It is not intended to be exhaustive or to limit the invention to the precise forms disclosed. Obviously, many modifications and variations will be apparent to practitioners skilled in the art. The present exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A binding device comprising:
a binding unit that forms plurality of asperities on a recording material bundle constituted by rectangular recording materials, and binds the recording material bundle, wherein,
in oblique binding in which the plurality of asperities are arranged on a corner portion of the recording material bundle in a direction inclined to one of both sides constituting the corner portion of the recording material bundle, a binding position by the binding unit reaches at least one of the both sides constituting the corner portion of the recording material bundle, and,
in parallel binding in which the plurality of asperities are arranged along a side of the recording material bundle, a binding position by the binding unit does not reach any side of the recording material bundle.

2. The binding device according to claim 1, further comprising: a moving unit that moves the binding unit to change a position and an angle of the binding unit in the recording material bundle.

3. The binding device according to claim 1, further comprising:
a recognition unit that recognizes print information when the recording material bundle is bound by the oblique binding; and
a controller that controls a position of the binding unit to reach only one of the both sides in accordance with the print information recognized by the recognition unit.

4. A binding device comprising:
a binding unit that forms a binding mark including a plurality of asperities arranged in one direction on a recording material bundle constituted by rectangular recording materials, and binds the recording material bundle, wherein
the recording material bundle is bound by using the binding unit to make a length of the binding mark in corner-portion binding, which binds a corner portion of a recording material bundle, shorter as compared to a length of each of a plurality of binding marks in parallel binding, in which the plurality of binding marks are arranged along one of both sides constituting a corner portion of the recording material bundle.

5. The binding device according to claim 4, wherein the recording material bundle is bound by using the binding unit to make the binding mark in the corner-portion binding shorter than a maximum length of the binding mark that can be formed by the binding unit.

6. The binding device according to claim 5, wherein the recording material bundle is bound by using the binding unit to make the binding mark in the corner-portion binding inclined to or in parallel with one of both sides constituting a corner of the recording material bundle.

7. A binding device comprising:
a first binding unit that binds a recording material bundle by forming a plurality of asperities arranged over a first length at a corner portion of the recording material bundle; and
a second binding unit that binds a recording material bundle by forming a plurality of asperities arranged over a second length, which is longer than the first length, in parallel with one of both sides constituting a corner portion of the recording material bundle.

8. The binding device according to claim 7, wherein the second binding unit binds the recording material bundle by forming the plurality of asperities plural times.
